(19) United States
(12) Patent Application Publication
(10) Pub. No.: US 2022/0131995 A1
(43) Pub. Date: Apr. 28, 2022

(54) SYSTEMS WITH SCANNERS

(71) Applicant: Hewlett-Packard Development Company, L.P., Spring, TX (US)

(72) Inventors: Sai Horng Soo, Singapore (SG); Ginu Jacob, Singapore (SG)

(73) Assignee: Hewlett-Packard Development Company, L.P., Spring, TX (US)

(21) Appl. No.: 17/296,099

(22) PCT Filed: Apr. 15, 2019
(86) PCT No.: PCT/US2019/027458

§ 371 Date: May 21, 2021

(51) Int. Cl. H04N 1/203; H04N 1/00

(52) U.S. Cl. CPC H04N 1/2034; H04N 2201/0094; H04N 1/00822

(57) ABSTRACT

Examples of systems having scanners are described. In an example, a system includes a 3-channel scanner and a 1-channel scanner.

### BACKGROUND

Systems, such as scanning systems and printing systems, may be used to scan content present on media. An example of a medium may be a paper. Systems may be used for scanning a single side or both sides of a medium. Scanning a single side of a medium may be referred to as a simplex scanning. Scanning both sides of a medium may be referred to as a duplex scanning.

### BRIEF DESCRIPTION OF DRAWINGS

The following detailed description references the drawings, wherein:

FIG. 1 illustrates a system with scanners, according to an example;

FIG. 2 illustrates the system of FIG. 1 for a simplex scanning with a medium fed in an automatic document feeder of the system;

FIG. 3 illustrates the system of FIG. 2 for a simplex scanning with a medium kept on a flatbed unit of the system;

FIG. 4 illustrates the system of FIG. 2 for a duplex scanning with a medium fed in an automatic document feeder of the system;

FIG. 5 illustrates a system with scanners, according to an example;

FIG. 8 illustrates the system of FIG. 5 for a simplex scanning with a medium fed in an automatic document feeder of the system;

FIG. 7 illustrates the system of FIG. 6 for a duplex scanning with a medium fed in an automatic document feeder of the system; and

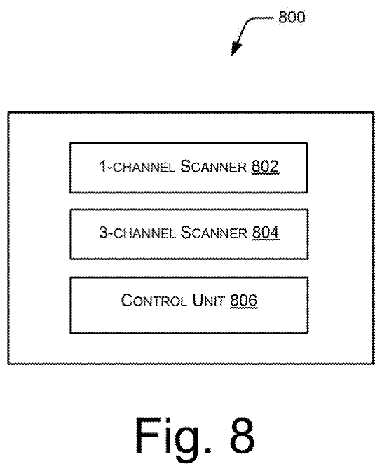

FIG. 8 illustrates a system with scanners, according to an example.

### DETAILED DESCRIPTION

Content from media, such as papers, can be scanned using a system with a scanner. Such a system may be a stand-alone scanning system or a print-cum-scanning system or a multi-purpose system with capabilities of scanning, printing, faxing, etc. The system may include an automatic document feeder which enables a user to feed multiple media at once for scanning, instead of manually replacing media one-by-one. The automatic document feeder facilitates in enhancing the speed of scanning.

The system with the automatic document feeder may be a single-scanner system or a dual-scanner system. A single-scanner system with the automatic document feeder may include a flatbed unit, and a scanner may be placed in the flatbed unit. For simplex scanning of a medium, the medium is fed in the automatic document feeder with the side to be scanned, i.e., the scanning side, facing up. The medium is automatically picked by the automatic document feeder and the scanning side is scanned by the scanner in the flatbed unit in a single pass of the medium through the automatic document feeder. The medium, after the first pass, is dispensed to an output region of the system. For duplex scanning of a medium, the side facing up, while feeding in the automatic document feeder, is scanned by the scanner in a first pass of the medium through the automatic document feeder. The medium after the first pass is again moved through the automatic document feeder to flip the sides, and the side facing down, while feeding in the automatic document feeder, is scanned by the scanner in a second pass of the medium through the automatic document feeder. The medium after the second pass is dispensed to the output region of the system. The two-pass duplex scanning of a medium in the single-scanner system with the automatic document feeder is slow because of a long path followed by the medium for duplex scanning. Components provided in the automatic document feeder which enable flipping of the medium for duplex scanning may cause noise during their operation.

A dual-scanner system with the automatic document feeder may include one 3-channel scanner in the flatbed unit of the system and one 3-channel scanner in the automatic document feeder of the system. Such a system may be referred to as a dual 3-channel/3-channel scanner system. A 3-channel scanner is able to scan content on a side of a medium relatively faster since the content on the side is divided into three sub-portions and scanning of the three sub-portions is done parallelly. For simplex scanning of a medium, the medium is fed in the automatic document feeder with the side to be scanned, i.e., the scanning side, facing up. The medium is automatically picked by the automatic document feeder and the scanning side is scanned by the 3-channel scanner in the flatbed unit in a single pass of the medium through the automatic document feeder. The medium, after the first pass, is dispensed to an output region of the system. The simplex scanning in a dual-scanner system is performed in the same manner as described earlier for the single-scanner system. For duplex scanning of a medium, the side facing up while feeding in the automatic document feeder is scanned by the 3-channel scanner in the flatbed unit and the side facing down while feeding in the automatic document feeder is scanned by the 3-channel scanner in the automatic document feeder simultaneously in a single pass. The medium after the single pass is dispensed to the output region of the system. The single-pass duplex scanning of a medium in the dual 3-channel/3-channel scanner system with the automatic document feeder is faster than that for the single-scanner system. Also, since the automatic document feeder does not have components for flipping of the medium for duplex scanning, the noise generated during duplex scanning is lesser than that for the single-scanner system. While, dual 3-channel/3-channel scanners enable fast duplex scanning of media and low noise during duplex scanning, such systems may be costly due to high cost of components used in a 3-channel scanner.

The present subject matter describes systems with two scanners, which facilitate duplex scanning of media at a faster speed that that for the single-scanner systems and are less costly in comparison to that of the dual 3-channel/3-channel scanners. The systems described herein are dual 3-channel/1-channel or dual 1-channel/3 channel scanners. In various examples, other channel configurations may be implemented in systems as described herein. For example, a system may include one scanner with more channels than a second channel to provide fast scanning in a simplex mode, and a duplex mode that uses the second scanner having fewer channels. For example, one scanner may have fewer or additional channels than the 3-channel scanners generally described, while the other scanner may have fewer scanners, such as the 1-channel scanner described. In some examples, the first scanner may have 3, 4, 5, 6, or another number of channels, while the other scanner may have fewer channels respectively. The scanners may be operated as described herein with respect to dual 3-channel and 1-channel examples.

The systems described herein are hybrid dual-scanner systems with one 1-channel scanner and one 3-channel scanner. A 3-channel scanner divides content on a side of a medium to be scanned into three sub-portions and scans the three sub-portions parallelly. A 1-channel scanner scans a side of a medium serially without dividing into sub-portions. Thus, the 3-channel scanner scans at a speed three times faster than the 1-channel scanner. The 3-channel scanner and the 1-channel scanner are configured in the system such that the 3-channel scanner is used for a simplex scanning of a medium fed in the automatic document feeder, with a single pass through the automatic document feeder. Further, the 3-channel scanner and the 1-channel scanner are configured in the system such that both scanners, the 3-channel and 1-channel scanners, are used for duplex scanning of a medium fed in the automatic document feeder, with a single pass through the automatic document feeder. The systems described herein facilitate duplex scanning of media at a faster speed than that for the single-scanner systems and are less costly in comparison to that of the dual 3-channel/3-channel scanners.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

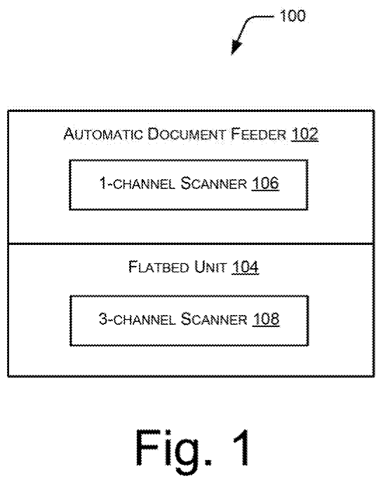

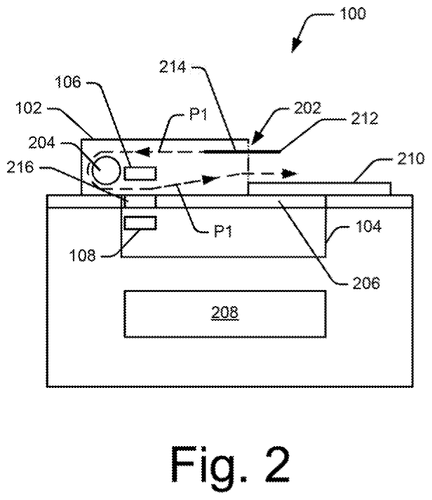

FIG. 1 illustrates a system 100 with scanners, according to an example. The system 100 may include, but is not restricted to, a scanning system, a print-cum-scanning system, and a multi-purpose system with capabilities of scanning, printing, faxing, etc. As shown in FIG. 1, the system 100 includes an automatic document feeder 102 and a flatbed unit 104. The automatic document feeder 102 is a unit to which multiple media, such as paper, can be fed for scanning. The automatic document feeder 102 picks the fed media one-by-one for the purpose of scanning. The flatbed unit 104 is a unit having a platen, of glass, over which media can be directly placed, one-by-one, for scanning. The media if scanned by placing over the flatbed unit 104 may be manually replaced one-by-one.

The automatic document feeder 102, apart from other components, includes a 1-channel scanner 106. The flatbed unit 104, apart from other components, includes a 3-channel scanner 108. The 3-channel scanner 108 in the flatbed unit 104 is operated and utilized for a simplex scanning of content on a medium, irrespective of whether the medium is kept on the flatbed unit 104 or the medium is received by the automatic document feeder 102. For duplex scanning of a medium, the automatic document feeder 102 is to receive the medium and the 3-channel scanner 108 of the flatbed unit 104 is operated and utilized for scanning the side that faces up when feeding the medium in the automatic document feeder 102 and the 1-channel scanner 106 of the automatic document feeder 102 is operated and utilized for scanning the side that faces down when feeding the medium in the automatic document feeder 102. Both the sides of the medium received in the automatic document feeder for duplex scanning are scanned in a single pass of the medium through the automatic document feeder 102.

FIG. 2 illustrates the system 100 of FIG. 1 for a simplex scanning with a medium fed in the automatic document feeder 102 of the system 100. As shown in FIG. 2, the automatic document feeder 102 has an opening 202 for feeding media for scanning. The 1-channel scanner 106 is in the automatic document feeder 102. The automatic document feeder 102 also has a rotary unit 204 to roll a medium thereacross for the purpose of scanning. As shown in FIG. 2, the flatbed unit 104 has a glass platen 206. The 3-channel scanner 108 is placed under the glass platen 206.

Further, the system 100 also includes a control unit 208. The control unit 208 may be implemented through a combination of any suitable hardware and computer-readable instructions. The control unit 208 may be implemented in a number of different ways to perform various functions for the purposes of scanning media using the system 100. For example, the computer-readable instructions for the control unit 208 may be processor-executable instructions stored in a non-transitory computer-readable storage medium, and the hardware for the control unit 208 may include a processing resource to execute such instructions for scanning media using the system 100. In some examples, the non-transitory computer-readable storage medium may store instructions which, when executed by the processing resource, implement the control unit 208. The processing resource may be implemented as microprocessors, microcomputers, microcontrollers, digital signal processors, central processing units, state machines, logic circuitries, or any devices that manipulate signals based on operational instructions. Among other capabilities, the processing resource may fetch and execute computer-readable instructions stored in a non-transitory computer-readable storage medium. The non-transitory computer-readable storage medium may include, for example, volatile memory (e.g., random-access memory (RAM)), or non-volatile memory (e.g., erasable programmable read-only memory (EPROM), flash memory, non-volatile random-access memory (NVRAM), memristor, etc.). In an example, the control unit 208 may be implemented by electronic circuitry.

The description hereinafter describes a simplex scanning of a medium using the automatic document feeder 102. A path, P1, followed by a medium from the opening 202 in the automatic document feeder 102 to an output region 210 of the automatic document feeder 102 is shown in FIG. 2. For simplex scanning using the automatic document feeder 102, the automatic document feeder 102 receives a first medium 212 through the opening 202. The first medium 212 is placed in the opening 202 in a manner such that the side to be scanned, i.e., the scanning side 214, is faced up. Upon feeding the first medium 212 with the scanning side 214 facing up, a user may provide a first input indicative of a simplex scanning of the first medium 212 to the system 100. The control unit 208 receives the first input indicative of the simplex scanning of the first medium and, in response to receiving the first input, operates the automatic document feeder 102 such that the automatic document feeder 102 picks up the first medium 212 to move the first medium along the path P1 and operates the 3-channel scanner 108 of the flatbed unit 104 to scan the scanning side 214 of the first medium 212.

To describe in detail, upon rotating over the rotary unit 204, the scanning side 214 of the first medium 212 approaches a scanning window 216 of the glass platen 206 of the flatbed unit 104. The scanning window may be a region of the glass platen 206 through which the 3-channel scanner 108 in the flatbed unit 104 may scan contents on a medium passing through the automatic document feeder 102. As the scanning side 214 of the first medium 212 moves across the scanning window 216, the 3-channel scanner 108 of the flatbed unit 104 scans the contents on the scanning side 214 of the first medium. The first medium 212, after passing over the scanning window 216, moves further along the path P1 and is dispensed to the output region 210. In an example, data associated with the scanned contents may be stored in a memory (not shown) of the system 100 for further actions, such as printing, faxing, etc.

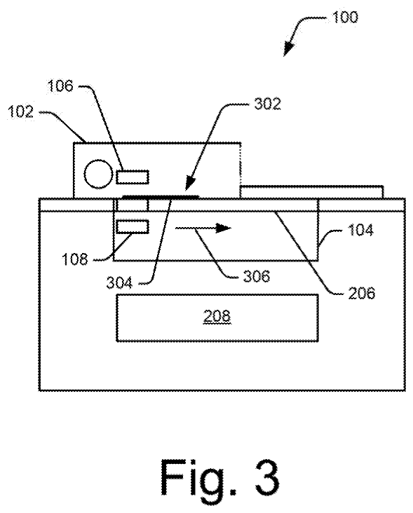

FIG. 3 illustrates the system 100 of FIG. 2 for a simplex scanning with a medium kept on the flatbed unit 104 of the system 100. As shown in FIG. 3, a medium 302, the same as the first medium 212, is placed on the glass platen 206 of the flatbed unit 104. The medium 302 is placed in a manner such that the side to be scanned, i.e., the scanning side 304, is faced down. Upon keeping the medium 302 on the glass platen 206, the user may provide a first input, the same as described with reference to FIG. 2, indicative of a simplex scanning of the medium 302 to the system 100. The control unit 208 receives the first input indicative of the simplex scanning of the medium 302 and, in response to receiving the first input, operates the 3-channel scanner 108 of the flatbed unit 104 to scan the scanning side 304 of the medium 302. For the scanning the contents on the scanning side 304 of the medium 302 kept on the glass platen 206, the control unit 208 instructs the 3-channel scanner 108 to move in a direction referenced by arrow 306 to span the flatbed unit 104. In an example, the 3-channel scanner 108 may move in a direction opposite to the direction referenced by arrow 306 to span the flatbed unit 104. The medium 302, after scanning, may be removed by user. In an example, data associated with the scanned contents may be stored in a memory (not shown) of the system 100 for further actions, such as printing, faxing, etc.

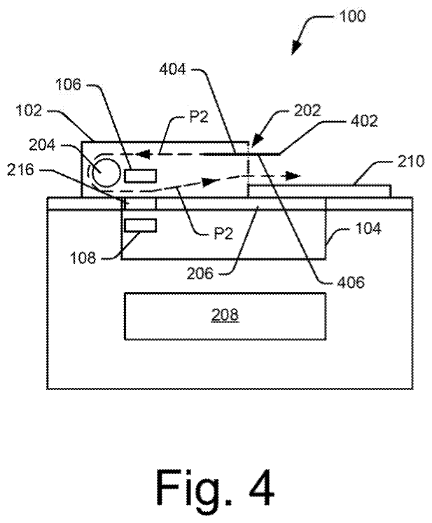

FIG. 4 illustrates the system of FIG. 2 for a duplex scanning with a medium fed in the automatic document feeder 102 of the system 100. As shown in FIG. 4, the automatic document feeder 102 receives a second medium 402 through the opening 202 for duplex scanning. A path, P2, followed by the second medium 402 from the opening 202 in the automatic document feeder 102 to the output region 210 of the automatic document feeder 102 is shown in FIG. 4.

Upon feeding the second medium 402, a user may provide a second input indicative of a duplex scanning of the second medium 402 to the system 100. The control unit 208 receives the second input indicative of the duplex scanning of the second medium 402 and, in response to receiving the second input, operates the automatic document feeder 102 such that the automatic document feeder 102 picks up the second medium 402 to move the second medium along the path P2, operates the 3-channel scanner 108 of the flatbed unit 104 to scan a first side 404 of the second medium 402, and operates the 1-channel scanner 106 of the automatic document feeder 102 to scan a second side 406 of the second medium 402.

To describe in detail, upon rotating over the rotary unit 204, the first side 404 of the second medium 402 approaches the scanning window 216 of the glass platen 206 of the flatbed unit 104 and the second side of the second medium 402 approaches the 1-channel scanner 106. As the first side 404 of the second medium 402 moves across the scanning window 216, the 3-channel scanner 108 of the flatbed unit 104 scans the contents on the first side 404 of the second medium 402. Similarly, as the second side 406 of the second medium 402 moves under the 1-channel scanner 106, the 1-channel scanner 106 scans the contents on the second side 406 of the second medium 402. The second medium 402, after passing over the scanning window 216, moves further along the path P2 and is dispensed to the output region 210. In an example, data associated with the scanned contents may be stored in a memory (not shown) of the system 100 for further actions, such as printing, faxing, etc. In an example, the control unit 208 causes scan timing for the duplex scanning to correspond to scan timing associated with the 1-channel scanner 106.

It may be noted that, in FIGS. 2 to 4, the opening 202 in the automatic document feeder 102 is on top and the output region 210 is at bottom, i.e., below the opening 202. In another example, the output region of the system may be on top and the opening in the automatic document feeder through which media is fed may be at bottom, i.e., below the output region. In such a system, for simplex scanning using the automatic document feeder, a medium is fed in the automatic document feeder through the opening such that the side to be scanned, i.e., the scanning side, is faced down. For duplex scanning, the side of a medium facing down while feeding in the automatic document feeder is scanned using the 3-channel scanner in the flatbed unit and the side of the medium facing up while feeding in the automatic document feeder is scanned using the 1-channel scanner in the automatic document feeder.

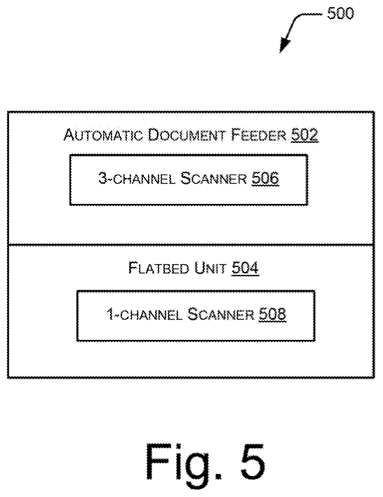

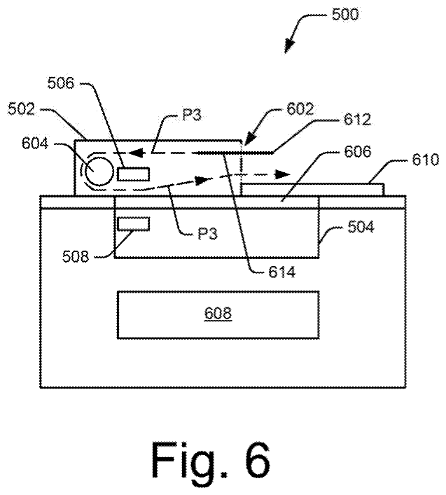

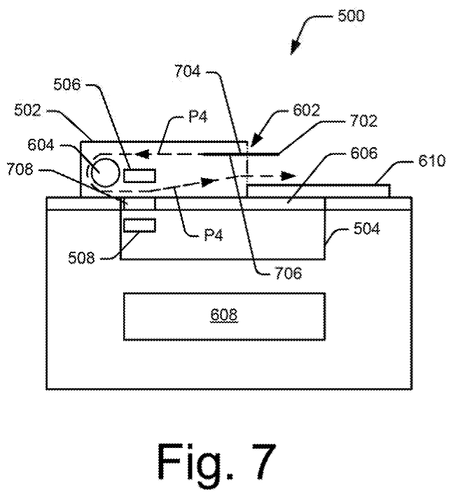

FIG. 5 illustrates a system 500 with scanners, according to an example. The system 500 may include, but is not restricted to, a scanning system, a print-cum-scanning system, and a multi-purpose system with capabilities of scanning, printing, faxing, etc. As shown in FIG. 5, the system 500 includes an automatic document feeder 502 and a flatbed unit 504. The automatic document feeder 502, apart from other components, includes a 3-channel scanner 506. The flatbed unit 504, apart from other components, includes a 1-channel scanner 508.

The 3-channel scanner 506 in the automatic document feeder 502 is operated and utilized for simplex scanning of content on a medium, when the medium is fed in the automatic document feeder 502. For duplex scanning of a medium fed in the automatic document feeder 502, the 1-channel scanner 508 of the flatbed unit 504 is operated and utilized for scanning the side that faces up when feeding the medium in the automatic document feeder 502 and the 3-channel scanner 506 of the automatic document feeder 502 is operated and utilized for scanning the side that faces down when feeding the medium in the automatic document feeder 502. Both the sides of the medium fed in the automatic document feeder 502 for duplex scanning are scanned in a single pass of the medium through the automatic document feeder 502.

FIG. 6 illustrates the system 500 of FIG. 5 for a simplex scanning with a medium fed in the automatic document feeder 502 of the system 500. As shown in FIG. 5, the automatic document feeder 502 has an opening 602 for feeding media for scanning. The opening 602 is similar to the opening 202 of the automatic document feeder 102. The 3-channel scanner 506 is in the automatic document feeder 502. The automatic document feeder 502 also has a rotary unit 604 to roll a medium thereacross for the purpose of scanning. As shown in FIG. 6, the flatbed unit 504 has a glass platen 606, which may be similar to the glass platen 206 of the flatbed unit 104. The 1-channel scanner 508 is placed under the glass platen 606.

Further, the system 500 also includes a control unit 608. The control unit 608 may be implemented through a combination of any suitable hardware and computer-readable instructions. The control unit 608 may be implemented in a number of different ways to perform various functions for the purposes of scanning media using the system 500. For example, the computer-readable instructions for the control unit 608 may be processor-executable instructions stored in a non-transitory computer-readable storage medium, and the hardware for the control unit 608 may include a processing resource to execute such instructions for scanning media using the system 500. In some examples, the non-transitory computer-readable storage medium may store instructions which, when executed by the processing resource, implement the control unit 608. The processing resource may be implemented as microprocessors, microcomputers, microcontrollers, digital signal processors, central processing units, state machines, logic circuitries, or any devices that manipulate signals based on operational instructions. Among other capabilities, the processing resource may fetch and execute computer-readable instructions stored in a non-transitory computer-readable storage medium. The non-transitory computer-readable storage medium may include, for example, volatile memory (e.g., random-access memory (RAM)), or non-volatile memory (e.g., erasable programmable read-only memory (EPROM), flash memory, non-volatile random-access memory (NVRAM), memristor, etc.). In an example, the control unit 608 may be implemented by electronic circuitry.

The description hereinafter describes a simplex scanning of a medium using the automatic document feeder 502. A path, P3, followed by a medium from the opening 602 in the automatic document feeder 502 to an output region 610 of the automatic document feeder 502 is shown in FIG. 6. For simplex scanning using the automatic document feeder 502, the automatic document feeder 502 receives a first medium 612 through the opening 602. The first medium 612 is placed in the opening 602 in a manner such that the side to be scanned, i.e., the scanning side 614, is faced down. Upon feeding the first medium 612 with the scanning side 614 facing down, a user may provide a first input indicative of a simplex scanning of the first medium 612 to the system 500. The control unit 608 receives the first input indicative of the simplex scanning of the first medium 612 and, in response to receiving the first input, operates the automatic document feeder 502 such that the automatic document feeder 502 picks up the first medium 612 to move the first medium 612 along the path P3 and operates the 3-channel scanner 506 of the automatic document feeder 502 to scan the scanning side 614 of the first medium 612. To describe in detail, upon rotating over the rotary unit 604, the scanning side 614 of the first medium 612 approaches the 3-channel scanner 506 of the automatic document feeder 502. As the scanning side 614 of the first medium 612 moves under the 3-channel scanner 506, the 3-channel scanner 506 scans the contents on the scanning side 614 of the first medium 612. The first medium 612, after passing under the 3-channel scanner 506, moves further along the path P3 and is dispensed to the output region 610. In an example, data associated with the scanned contents may be stored in a memory (not shown) of the system 500 for further actions, such as printing, faxing, etc.

FIG. 7 illustrates the system 500 of FIG. 6 for a duplex scanning with a medium fed in the automatic document feeder 502 of the system 500. As shown in FIG. 7, the automatic document feeder 502 receives a second medium 702 through the opening 602 for duplex scanning. A path, P4, followed by the second medium 702 from the opening 602 in the automatic document feeder 502 to the output region 610 of the automatic document feeder 502 is shown in FIG. 7.

Upon feeding the second medium 702, a user may provide a second input indicative of a duplex scanning of the second medium 702 to the system 500. The control unit 608 receives the second input indicative of the duplex scanning of the second medium 702 and, in response to receiving the second input, operates the automatic document feeder 502 such that the automatic document feeder 502 picks up the second medium 702 to move the second medium 702 along the path P4, operates the 1-channel scanner 508 of the flatbed unit 504 to scan a first side 704 of the second medium 702, and operates the 3-channel scanner 506 of the automatic document feeder 502 to scan a second side 706 of the second medium 702.

To describe in detail, upon rotating over the rotary unit 604, the first side 704 of the second medium 702 approaches a scanning window 708 of the glass platen 606 of the flatbed unit 504 and the second side 706 of the second medium 702 approaches the 3-channel scanner 506 of the automatic document feeder 502. The scanning window 708 may be a region of the glass platen 606 through which the 1-channel scanner 508 in the flatbed unit 504 may scan contents on a medium passing through the automatic document feeder 502. As the first side 704 of the second medium 702 moves across the scanning window 708, the 1-channel scanner 508 of the flatbed unit 504 scans the contents on the first side 704 of the second medium 702. Similarly, as the second side 706 of the second medium 702 moves under the 3-channel scanner 506, the 3-channel scanner 506 scans the contents on the second side 706 of the second medium 702. The second medium 702, after passing over the scanning window 708, moves further along the path P4 and is dispensed to the output region 610. In an example, data associated with the scanned contents may be stored in a memory (not shown) of the system 500 for further actions, such as printing, faxing, etc. In an example, the control unit 608 causes scan timing for the duplex scanning to correspond to scan timing associated with the 1-channel scanner 508. The scan timing associated with the 1-channel scanner may refer to the time taken by the 1-channel scanner to scan one side of a medium. The scan timing associated with the 3-channel scanner may refer to the time taken by the 3-channel scanner to scan one side of a medium.

It may be noted that, in FIGS. 6 and 7, the opening 602 in the automatic document feeder 502 is on top and the output region 610 is at bottom, i.e., below the opening 602. In another example, the output region of the system may be on top and the opening in the automatic document feeder through which media is fed may be at bottom, i.e., below the output region. In such a system, for simplex scanning using the automatic document feeder, a medium is fed in the automatic document feeder through the opening such that the side to be scanned, i.e., the scanning side, is faced up. For duplex scanning, the side of a medium facing up while feeding in the automatic document feeder is scanned using the 3-channel scanner in the automatic document feeder and the side of the medium facing down while feeding in the automatic document feeder is scanned using the 1-channel scanner in the flatbed unit.

FIG. 8 illustrates a system 800 with scanners, according to an example. The system 800 may include, but is not restricted to, a scanning system, a print-cum-scanning system, and a multi-purpose system with capabilities of scanning, printing, faxing, etc. As shown in FIG. 8, the system 800 includes a 1-channel scanner 802, a 3-channel scanner 804, and a control unit 806. The 1-channel scanner 802 may be similar to the 1-channel scanner 106 and 508. The 3-channel scanner 804 may be similar to the 3-channel scanner 108 and 506.

The control unit 806 may be implemented through a combination of any suitable hardware and computer-readable instructions. The control unit 806 may be implemented in a number of different ways to perform various functions for the purposes of scanning media using the system 800. For example, the computer-readable instructions for the control unit 806 may be processor-executable instructions stored in a non-transitory computer-readable storage medium, and the hardware for the control unit 806 may include a processing resource to execute such instructions for scanning media using the system 800. In some examples, the non-transitory computer-readable storage medium may store instructions which, when executed by the processing resource, implement the control unit 806. The processing resource may be implemented as microprocessors, microcomputers, microcontrollers, digital signal processors, central processing units, state machines, logic circuitries, or any devices that manipulate signals based on operational instructions. Among other capabilities, the processing resource may fetch and execute computer-readable instructions stored in a non-transitory computer-readable storage medium. The non-transitory computer-readable storage medium may include, for example, volatile memory (e.g., random-access memory (RAM)), or non-volatile memory (e.g., erasable programmable read-only memory (EPROM), flash memory, non-volatile random-access memory (NVRAM), memristor, etc.). In an example, the control unit 806 may be implemented by electronic circuitry.

The control unit 806 is coupled to the 1-channel scanner 802 and the 3-channel scanner 804 so as to operate the 3-channel scanner 804 to scan a first medium in response to receiving a first input indicative of a simplex scanning of the first medium. Further, the control unit 806 is coupled to the 1-channel scanner 802 and the 3-channel scanner 804 so as to operate the 3-channel scanner 804 to scan a first side of a second medium and operate the 1-channel scanner 802 to scan a second side of the second medium in response to receiving a second input indicative of a duplex scanning of the second medium. In an example, the first input and the second input may be provided by a user.

In an example, the system 800 may include an automatic document feeder (not shown in FIG. 8), but not a flatbed unit. In such a system, the 1-channel scanner 802, the 3-channel scanner 804, and the automatic document feeder are positioned such that a path followed by a medium when fed in the automatic document feeder for the purpose of scanning passes between the 1-channel scanner 802 and the 3-channel scanner 804. For simplex scanning, a medium is fed in the automatic document feeder such that the side, of the medium, to be scanned faces the 3-channel scanner 804 while passing through the automatic document feeder. The control unit 806 may accordingly operate the 3-channel scanner 804 to scan the medium. For duplex scanning, a medium may be fed in the automatic document feeder, and the control unit 806 may accordingly operate the 3-channel scanner 804 to scan one side of the medium and operate the 1-channel scanner 802 to scan the other side of the medium.

In an example, the system 800 may include a flatbed unit and an automatic document feeder, where the flatbed unit includes the 3-channel scanner 804 and the automatic document feeder includes the 1-channel scanner 802. Such a system may be similar to the system 100, as described with respect to FIGS. 1 to 4.

Although examples for the present disclosure have been described in language specific to structural features, it is to be understood that the appended claims are not limited to the specific features described herein. Rather, the specific features are disclosed and explained as examples of the present disclosure.

We claim:

1. A system comprising:
a flatbed unit comprising a 3-channel scanner; and
an automatic document feeder comprising a 1-channel scanner.

2. The system as claimed in claim 1, further comprising a control unit to:
receive a first input indicative of a simplex scanning of a first medium; and
operate the 3-channel scanner of the flatbed unit to scan the first medium in response to receiving the first input.

3. The system as claimed in claim 2, wherein the automatic document feeder is to receive the first medium.

4. The system as claimed in claim 2, wherein to operate the 3-channel scanner, the control unit is to instruct the 3-scanner channel to move in a direction to span the flatbed unit.

5. The system as claimed in claim 2, wherein the control unit is to:
receive a second input indicative of a duplex scanning of a second medium; and
in response to receiving the second input:
operate the 3-channel scanner of the flatbed unit to scan a first side of the second medium; and
operate the 1-channel scanner of the automatic document feeder to scan a second side of the second medium.

6. The system as claimed in claim 5, wherein the control unit causes scan timing for the duplex scanning to correspond to scan timing associated with the 1-channel scanner.

7. The system as claimed in claim 5, wherein the automatic document feeder is to receive the second medium.

8. A system comprising:
a flatbed unit comprising a 1-channel scanner; and
an automatic document feeder comprising a 3-channel scanner.

9. The system as claimed in claim 8, further comprising a control unit to:
receive a first input indicative of a simplex scanning of a first medium; and
operate the 3-channel scanner of the automatic document feeder to scan the first medium in response to receiving the first input.

10. The system as claimed in claim 9, wherein the automatic document feeder is to receive the first medium.

11. The system as claimed in claim 9, wherein the control unit is to:
receive a second input indicative of a duplex scanning of a second medium; and
in response to receiving the second input:
operate the 3-channel scanner of the automatic document feeder to scan a first side of the second medium; and
operate the 1-channel scanner of the flatbed unit to scan a second side of the second medium.

12. The system as claimed in claim 11, wherein the control unit causes scan timing for the duplex scanning to correspond to scan timing associated with the 1-channel scanner.

13. The system as claimed in claim 11, wherein the automatic document feeder is to receive the second medium.

14. A system comprising:
a 1-channel scanner;
a 3-channel scanner; and
a control unit coupled to the 1-channel scanner and 3-channel scanner, to:
operate the 3-channel scanner to scan a first medium in response to receiving a first input indicative of a simplex scanning of the first medium; and
operate the 3-channel scanner to scan a first side of a second medium and operate the 1-channel scanner to scan a second side of the second medium in response to receiving a second input indicative of a duplex scanning of the second medium.

15. The system as claimed in claim 14, further comprising:
a flatbed unit comprising the 3-channel scanner; and
an automatic document feeder comprising the 1-channel scanner.
